(19) United States
(12) Patent Application Publication
(10) Pub. No.: US 2015/0154593 A1
(43) Pub. Date: Jun. 4, 2015

(54) METHOD, SERVER AND SYSTEM FOR SECURE PAYMENT

(71) Applicant: TENCENT TECHNOLOGY (SHENZHEN) COMPANY LIMITED, Shenzhen (CN)

(72) Inventor: MAOCAI LI, Shenzhen (CN)

(73) Assignee: TENCENT TECHNOLOGY (SHENZHEN) COMPANY LIMITED

(21) Appl. No.: 14/615,485

(22) Filed: Feb. 6, 2015

Related U.S. Application Data
(63) Continuation of application No. PCT/CN2014/079553, filed on Jun. 10, 2014.

(30) Foreign Application Priority Data
Nov. 15, 2013 (CN) 2013-10574737.X

(51) Int. Cl. G06Q 20/38; G06Q 20/42

(52) U.S. Cl. CPC G06Q 20/382; G06Q 20/42

(57) ABSTRACT

A secure payment method is provided. The method includes a payment server receiving order payment information from a first user terminal, where the order payment information includes a login account of the first user terminal and a transaction order. The method also includes the payment server sending payment request information to a second user terminal associated with the first user terminal based on the login account of the first user terminal, where the payment request information contains the transaction order, and the second user terminal is a mobile terminal. Further, the method includes the payment server receiving payment confirmation information from the second user terminal based on the payment request information, where the payment confirmation information contains a payment account and verification information inputted by a user. The method includes the payment server performing a payment operation for the transaction order based on the payment confirmation information.

### CROSS-REFERENCES TO RELATED APPLICATIONS

This application is a continuation application of PCT Patent Application No. PCT/CN2014/079553, filed on Jun. 10, 2014, which claims priority of Chinese Patent Application No. 201310574737.X, filed on Nov. 15, 2013, the entire contents of which are incorporated by reference herein.

### FIELD OF THE INVENTION

The present invention generally relates to the field of Internet technologies and, more particularly, to methods, servers and systems for secure payment.

### BACKGROUND

With the rapid development of Internet technologies, online payments using Internet have become a fast and convenient payment method. In practical applications, because privacy and security of computers are not as good as privacy and security of mobile phones and other mobile terminals, more and more users choose to make online payments using the mobile terminals. However, Interne browsing experience on the mobile terminals is often not as good as Internet browsing experience on personal computers (PCs). Therefore, a user often needs to browse products on a PC and record information about the selected product. Then, the user searches the selected product again on a mobile phone and makes an online payment, making an entire payment process very cumbersome, thereby reducing efficiency of the online payment.

The disclosed methods, servers and systems are directed to solve one or more problems set forth above and other problems.

### BRIEF SUMMARY OF THE DISCLOSURE

One aspect of the present disclosure includes a secure payment method. The method includes a payment server receiving order payment information from a first user terminal, where the order payment information includes a login account of the first user terminal and a transaction order. The method also includes the payment server sending payment request information to a second user terminal associated with the first user terminal based on the login account of the first user terminal, where the payment request information contains the transaction order, and the second user terminal is a mobile terminal. Further, the method includes the payment server receiving payment confirmation information from the second user terminal based on the payment request information, where the payment confirmation information contains a payment account and verification information inputted by a user. The method includes the payment server performing a payment operation for the transaction order based on the payment confirmation information and returning a payment operation result of the transaction order to the first user terminal.

Another aspect of the present disclosure includes a payment server. The server includes a receiving unit configured to acquire order payment information sent from a first user terminal, where the order payment information includes a login account of the first user terminal and a transaction order. The server also includes a sending unit configured to send payment request information to a second user terminal associated with the first user terminal based on the login account of the first user terminal, where the payment request information contains the transaction order, and the second user terminal is a mobile terminal. Further, the server includes the receiving unit configured to receive payment confirmation information returned from the second user terminal based on the payment request information, where the payment confirmation information contains a payment account and verification information inputted by a user on the second user terminal in respond to the payment request information. The server includes an operation unit configured to perform a payment operation for the transaction order based on the payment confirmation information. The server also includes an authentication unit configured to determine whether the verification information in the payment confirmation information is the same as predetermined verification information of the payment account and a login terminal query unit configured to acquire login terminal information of the login account of the first user terminal, where the login terminal information includes a terminal identifier of the first user terminal and a terminal identifier of the second user terminal.

Another aspect of the present disclosure includes a secure payment system. The system includes a first user terminal configured to send order payment information to a payment server, where the order payment information includes a login account of the first user terminal and a transaction order. The system also includes the payment server configured to, based on the login account of the first user terminal, send payment request information to a second user terminal associated with the first user terminal, where the payment request information contains the transaction order, and the second user terminal is a mobile terminal. The system includes the second user terminal configured to, based on the payment request information, send payment confirmation information to the payment server, where the payment confirmation information contains a payment account and verification information inputted by a user. Further, the system includes the payment server also configured to, based on the payment confirmation information sent by the second user terminal, perform a payment operation for the transaction order.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 illustrates a flow chart of an exemplary secure payment process consistent with the disclosed embodiments;

FIG. 2 illustrates a schematic diagram of an exemplary interface that a user terminal prompts a user to input fingerprint information in a fingerprint input area consistent with the disclosed embodiments;

FIG. 3 illustrates a schematic diagram of an exemplary display interface for confirming a payment request on a user terminal consistent with the disclosed embodiments;

FIG. 4 illustrates a flow chart of another exemplary secure payment process consistent with the disclosed embodiments;

FIG. 5 illustrates a flow chart of another exemplary secure payment process consistent with the disclosed embodiments;

FIG. 6 illustrates a structure schematic diagram of an exemplary payment server consistent with the disclosed embodiments;

FIG. 7 illustrates a structure schematic diagram of another exemplary payment server consistent with the disclosed embodiments; and

FIG. 8 illustrates a structure schematic diagram of an exemplary secure payment system consistent with the disclosed embodiment.

### DETAILED DESCRIPTION

In order to explain the objectives, technical solutions and advantages of the present invention more clearly, the embodiments of the present invention will be further described in detail below in conjunction with the drawings.

A secure payment method may be implemented by a payment server. The payment server may be a back-end server for a payment platform, such as PayPal, AliPay, Tenpay, etc. Based on an acquired login account of a first user terminal, the payment server sends payment request information to a second user terminal associated with the first user terminal. The payment server also receives payment confirmation information returned from the second user terminal based on the payment request information. Further, based on the payment confirmation information, the payment server performs a payment operation for a transaction order sent by the first user terminal. The first user terminal may include Tablet personal computers (PCs), Pocket PCs, desktop computers, laptop computers, etc. The second user terminal may include smartphones (such as Android mobile phones, iOS mobile phones, BlackBerry mobile phones, and Windows phones), Mobile Internet Devices (MID), wearable smart devices, personal digital assistants (PDAs), and portable multimedia players (PMPs), and other mobile terminals. The login account may be a log on account for the payment server, a payment account, etc. The transaction order may include product information (e.g. product name, price, quantity, etc.), an order number, etc.

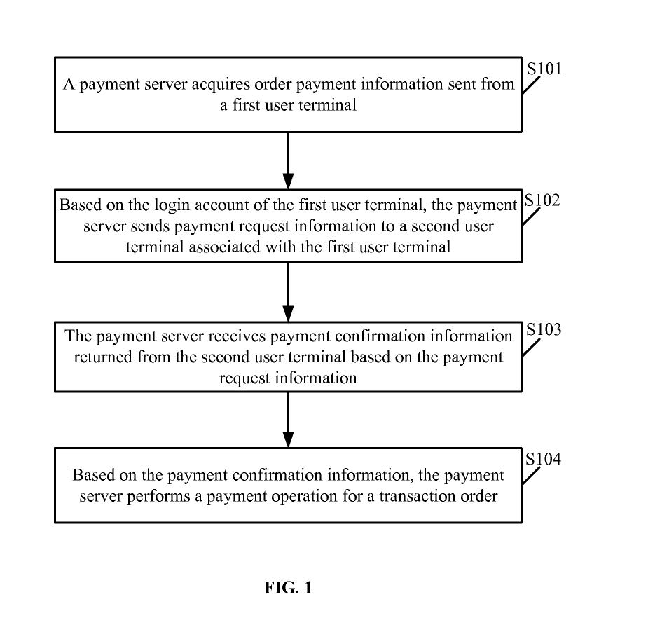

FIG. 1 illustrates a flow chart of an exemplary secure payment process consistent with the disclosed embodiments. The secure payment process shown in FIG. 1 is described from a payment server side. As shown in FIG. 1, the secure payment process may include the following steps.

S101: a payment server acquires order payment information sent from a first user terminal.

The payment server acquires the order payment information sent from the first user terminal, where the order payment information may include a login account of the first user terminal and a transaction order.

Optionally, the order payment information sent from the first user terminal and acquired by the payment server may also include a login account for the first user terminal to login the payment server and a transaction order, where the transaction order includes product information and an order number. Further, the order payment information may also include a payment account assigned by the first user terminal. In addition, the login account for the first user terminal to login the payment server can be the payment account assigned by the first user terminal.

S102: based on the login account of the first user terminal, the payment server sends payment request information to a second user terminal associated with the first user terminal.

Based on the login account of the first user terminal, the payment server sends the payment request information to the second user terminal associated with the first user terminal. If the order payment information sent from the first user terminal and acquired by the payment server includes the login account for the first user terminal to login the payment server and the transaction order, the payment request information contains the transaction order. If the order payment information sent from the first user terminal and acquired by the payment server includes the payment account assigned by the first user terminal, the payment request information contains the transaction order and the payment account.

Optionally, before the payment server sends the payment request information to the second user terminal associated with the first user terminal, the payment server can also receive payment terminal setting information sent from the first user terminal or the second user terminal, and set the second user terminal as a payment terminal associated with the first user terminal based on the payment terminal setting information.

Specifically, the payment server acquires login terminal information of the login account of the first user terminal, where the login terminal information may include a terminal identifier of the first user terminal and a terminal identifier of the second user terminal. Further, based on the terminal identifier of the second user terminal, the payment server sends the payment request information to the second user terminal.

Optionally, after the payment server acquires the order payment information sent from the first user terminal, the payment server may acquire the login terminal information of the login account of the first user terminal, where the login terminal information may include a terminal identifier of the first user terminal and terminal identifiers of at least two user terminals that use the same login account as the first user terminal. Further, the payment server sends the login terminal information to the first user terminal, such that the first user terminal determines that the assigned user terminal in the at least two user terminals is the payment terminal associated with the first user terminal, and returns the terminal identifier of the assigned user terminal. Then, based on the terminal identifier of the assigned user terminal, the payment server sends the payment request information to the assigned user terminal.

S103: the payment server receives payment confirmation information returned from the second user terminal based on the payment request information.

If the order payment information sent from the first user terminal and acquired by the payment server includes the login account for the first user terminal to login the payment server and the transaction order (the transaction order includes product information and an order number), based on the login account of the first user terminal, the payment server sends the payment request information to the second user terminal associated with the first user terminal, such that the second user terminal returns the payment confirmation information corresponding to the payment request information, where the payment confirmation information may contain the payment account assigned by the second user terminal and verification information inputted by a user on the second user terminal in respond to the payment request information, and the verification information may include fingerprint information, voice information, password information, Short Messaging Service (SMS), and so on.

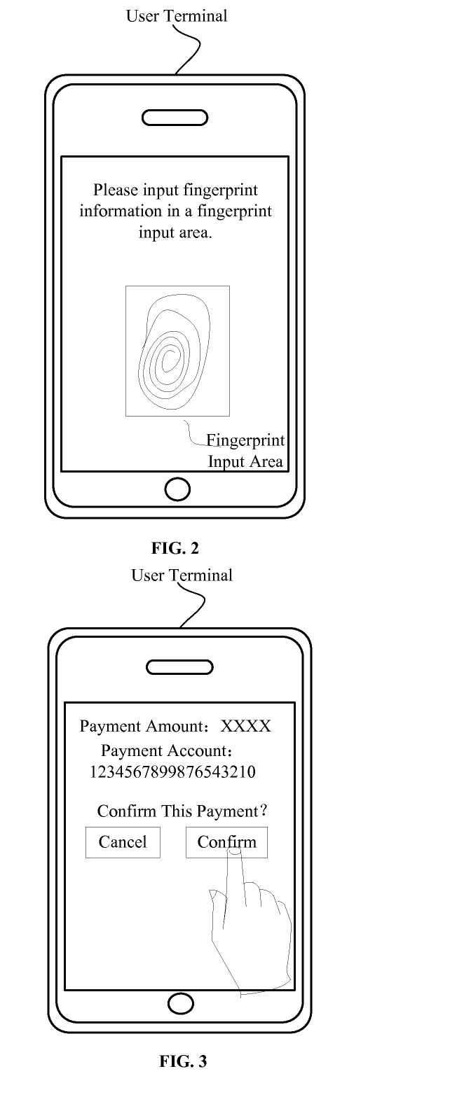

FIG. 2 illustrates a schematic diagram of an exemplary interface that a user terminal prompts a user to input fingerprint information in a fingerprint input area consistent with the disclosed embodiments. As shown in FIG. 2, based on payment request information, payment confirmation information returned from a second user terminal may contain a payment account assigned by the second user terminal and fingerprint information inputted by a user on the second user terminal in respond to the payment request information. The payment server may further determine whether the inputted fingerprint information is the same as predetermined fingerprint information of the payment account assigned by the second user terminal. If the inputted fingerprint information is the same as the predetermined fingerprint information, the process goes to S104; if the inputted fingerprint information is different from the predetermined fingerprint information, the payment server may return transaction failure information to the second user terminal.

If the order payment information sent from the first user terminal and acquired by the payment server includes the payment account assigned by the first user terminal and the transaction order (the transaction order includes the product information and the order number), based on the payment account of the first user terminal, the payment server sends the payment request information to the second user terminal associated with the first user terminal, such that the second user terminal returns the payment confirmation information corresponding to the payment request information, where the payment confirmation information contains verification information inputted by the user on the second user terminal in respond to the payment request information, and the verification information may include fingerprint information, voice information, password information, and so on. When the user on the second user terminal responds to the payment request information, the user can input the fingerprint information in the fingerprint input area shown in FIG. 2. The payment server may further determine whether the inputted fingerprint information is the same as predetermined fingerprint information of the payment account assigned by the first user terminal. If the inputted fingerprint information is the same as the predetermined fingerprint information, the process goes to S104; if the inputted fingerprint information is different from the predetermined fingerprint information, the payment server may return transaction failure information to the second user terminal.

FIG. 3 illustrates a schematic diagram of an exemplary display interface for confirming a payment request on a user terminal consistent with the disclosed embodiments. If order payment information sent by a first user terminal and acquired by a payment server includes a payment account of the first user terminal and a transaction order (the transaction order contains payment information, and the payment information contains product information and request information of payment amount to be paid using the payment account), the payment server sends payment request information to a second user terminal based on the payment account of the first user terminal. The second user terminal may output payment confirmation information to the payment server corresponding to the payment request information sent by the payment server, where the payment request information may contain the payment amount “XXXX”, and the payment account “123456789987654321”. Correspondingly, a user may click a “confirm” button on the display interface shown in FIG. 3, such that the payment confirmation response corresponding to the payment request information is sent to the second user terminal. Then, the second user terminal may send the payment confirmation information corresponding to the payment request information to the payment server. After the payment server receives the payment confirmation information, the process goes to S104.

S104: based on the payment confirmation information, the payment server performs a payment operation for the transaction order.

Based on the payment confirmation information sent from the second user terminal, the payment server performs the payment operation for the transaction order. Optionally, after the payment server performs the payment operation for the transaction order, the payment server sends a payment operation result of the transaction order to the first user terminal.

In the secure payment process shown in FIG. 1, based on the login account of the first user terminal, the payment server sends the payment request information to the second user terminal associated with the first user terminal. The payment server also receives the payment confirmation information returned from the second user terminal based on the payment request information. Further, based on the payment confirmation information, the payment server performs the payment operation for the transaction order sent from the first user terminal. The payment process is simplified, thereby improving efficiency of the online payment.

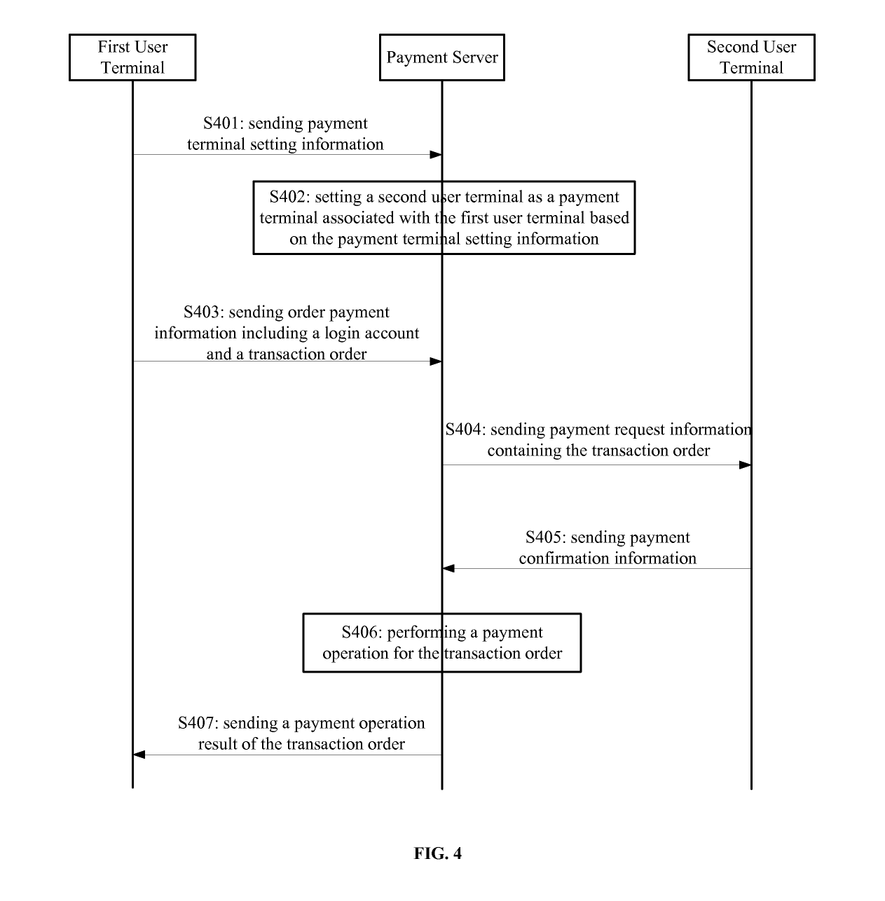

FIG. 4 illustrates a flow chart of another exemplary secure payment process consistent with the disclosed embodiments. As shown in FIG. 4, the secure payment process may include the following steps.

S401: a first user terminal sends payment terminal setting information to a payment server.

The first user terminal may send the payment terminal setting information to the payment server. Optionally, a second user terminal may also send the payment terminal setting information to the payment server.

S402: based on the payment terminal setting information, the payment server sets a second user terminal as a payment terminal associated with the first user terminal.

S403: the first user terminal sends order payment information to the payment server, where the order payment information includes a login account and a transaction order.

The order payment information sent from the first user terminal and acquired by the payment server may include the login account for the first user terminal to login the payment server and the transaction order, where the transaction order includes product information and an order number. Optionally, the order payment information sent from the first user terminal and acquired by the payment server may include a payment account assigned by the first user terminal. Further, the login account for the first user terminal to login the payment server can be the payment account assigned by the first user terminal.

S404: based on a terminal identifier of the second user terminal, the payment server sends payment request information to the second user terminal, where the payment request information contains the transaction order.

If the order payment information sent from the first user terminal and acquired by the payment server includes the login account for the first user terminal to login the payment server and the transaction order, the payment request information contains the transaction order. If the order payment information sent from the first user terminal and acquired by the payment server includes the payment account assigned by the first user terminal, the payment request information contains the transaction order and the payment account.

Specifically, the payment server may acquire login terminal information of the login account of the first user terminal, where the login terminal information may include terminal identifiers of the first user terminal and the second user terminal. Further, based on the terminal identifier of the second user terminal, the payment server may send the payment request information to the second user terminal.

S405: the second user terminal sends payment confirmation information to the payment server.

If the order payment information sent from the first user terminal and acquired by the payment server includes the login account for the first user terminal to login the payment server and the transaction order (the transaction order includes product information and an order number), based on the login account of the first user terminal, the payment server sends the payment request information to the second user terminal associated with the first user terminal, such that the second user terminal returns the payment confirmation information corresponding to the payment request information. The payment confirmation information contains the payment account assigned by the second user terminal and verification information inputted by a user on the second user terminal in respond to the payment request information, where the verification information includes fingerprint information, voice information, password information, and so on. The user on the second user terminal responds to the payment request information and inputs the fingerprint information in the fingerprint input area shown in FIG. 2. The payment server further determines whether the inputted fingerprint information is the same as the predetermined fingerprint information of the payment account assigned by the second user terminal. If the inputted fingerprint information is the same as the predetermined fingerprint information, the process goes to S406; if the inputted fingerprint information is different from the predetermined fingerprint information, the payment server returns transaction failure information to the second user terminal.

If the order payment information sent from the first user terminal and acquired by the payment server includes the payment account assigned by the first user terminal and the transaction order (the transaction order contains product information and an order number), based on the payment account of the first user terminal, the payment server sends the payment request information to the second user terminal associated with the first user terminal, such that the second user terminal returns the payment confirmation information corresponding to the payment request information. The payment confirmation information may contain verification information inputted by a user on the second user terminal in respond to the payment request information, where the verification information includes fingerprint information, voice information, password information, and so on. The user on the second user terminal responds to the payment request information and inputs fingerprint information in the fingerprint input area shown in FIG. 2. The payment server may further determine whether the inputted fingerprint information is the same as the predetermined fingerprint information of the payment account assigned by the first user terminal. If the inputted fingerprint information is the same as the predetermined fingerprint information, the process goes to S406; if the inputted fingerprint information is different from the predetermined fingerprint information, the payment server returns transaction failure information to the second user terminal.

If the order payment information sent from the first user terminal and acquired by the payment server includes the payment account of the first user terminal and the transaction order (the transaction order includes payment information, and the payment information includes product information and request information of payment amount to be paid using the payment account), based on the payment account of the first user terminal, the payment server sends the payment request information to the second user terminal (the payment request information includes payment amount and the payment account). Correspondingly, the user may click “confirm” button on the interface shown in FIG. 3, and input the payment confirmation information corresponding to the payment request information to the second user terminal. Correspondingly, the second user terminal may send the payment confirmation information corresponding to the payment request information to the payment server. After the payment server receives the payment confirmation information, the process goes to S406.

S406: the payment server performs a payment operation for the transaction order.

Based on the payment confirmation information sent from the second user terminal, the payment server performs the payment operation for the transaction order.

S407: the payment server sends a payment operation result of the transaction order to the first user terminal.

After performing the payment operation for the transaction order, the payment server may send the payment operation result of the transaction order to the first user terminal.

In the secure payment process shown in FIG. 4, the payment server sets the second user terminal as the payment terminal associated with the first user terminal. After acquiring the order payment information sent from the first user terminal, based on the login account of the first user terminal, the payment server sends the payment request information to the second user terminal. The payment server also receives the payment confirmation information returned from the second user terminal based on the payment request information. Further, based on the payment confirmation information, the payment server performs the payment operation for the transaction order sent from the first user terminal. The payment process is simplified, thereby improving efficiency of the online payment.

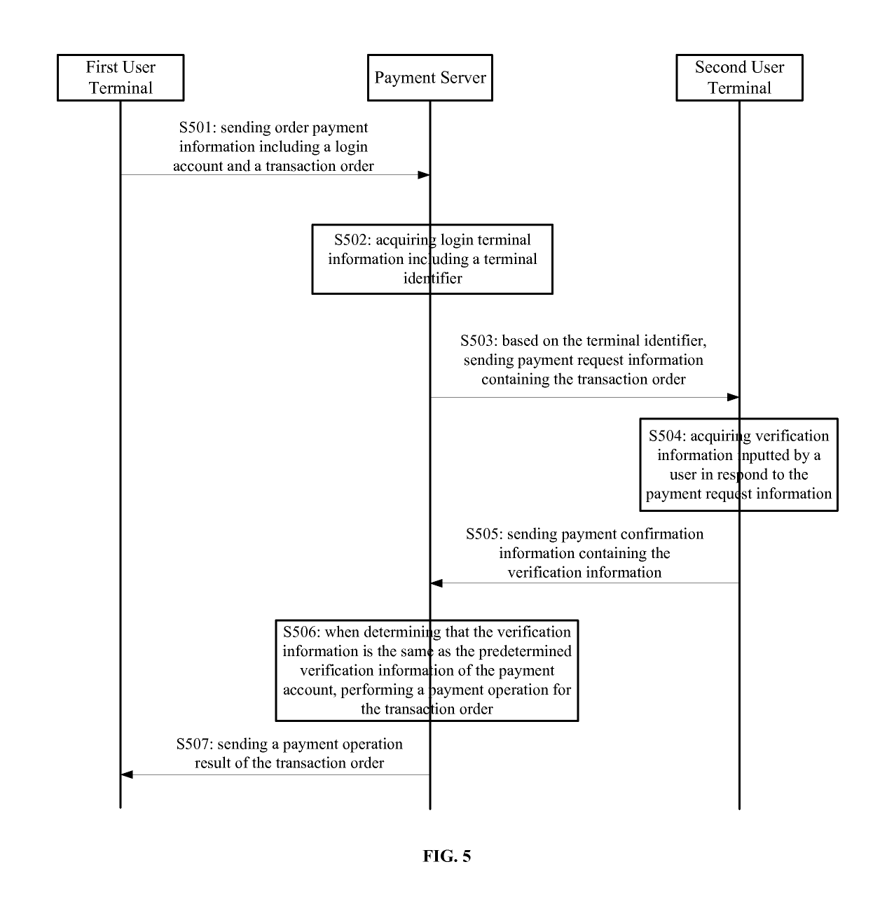

FIG. 5 illustrates a flow chart of another exemplary secure payment process consistent with the disclosed embodiments. As shown in FIG. 5, the secure payment process may include the following steps.

S501: a first user terminal sends order payment information to a payment server, where the order payment information includes a login account and a transaction order.

The order payment information sent from the first user terminal and acquired by the payment server may include the login account for the first user terminal to login the payment server and the transaction order, where the transaction order includes product information and an order number. Optionally, the order payment information sent from the first user terminal and acquired by the payment server may include a payment account assigned by the first user terminal. Further, the login account for the first user terminal to login the payment server can be the payment account assigned by the first user terminal.

S502: the payment server acquires login terminal information of the login account of the first user terminal, where the login terminal information may include a terminal identifier of the first user terminal and a terminal identifier of the second user terminal.

Specifically, after the payment server acquires the order payment information sent from the first user terminal, the payment server may acquire the login terminal information of the login account of the first user terminal, where the login terminal information may include a terminal identifier of the first user terminal and a terminal identifier of the second user terminal.

Optionally, after the payment server acquires the order payment information sent from the first user terminal, the payment server may acquire the login terminal information of the login account of the first user terminal, where the login terminal information may include a terminal identifier of the first user terminal and terminal identifiers of at least two user terminals that use the same login account as the first user terminal. Further, the payment server sends the login terminal information to the first user terminal, such that the first user terminal determines that the assigned user terminal in the at least two user terminals is the payment terminal associated with the first user terminal, and returns the terminal identifier of the assigned user terminal.

Optionally, before the payment server acquires the login terminal information of the login account of the first user terminal, the payment server can also receive payment terminal setting information sent from the first user terminal or the second user terminal, and set the second user terminal as the payment terminal associated with the first user terminal based on the payment terminal setting information.

Optionally, when at least two user terminals use the same login account as the first user terminal, the payment server may receive payment terminal setting information sent from the first user terminal or any one of the at least two user terminals that use the same login account as the first user terminal. Based on the payment terminal setting information, the payment server may also set the assigned user terminal of the at least two user terminals that use the same login account as the first user terminal as the payment terminal associated with the first user terminal.

S503: based on the terminal identifier of the second user terminal, the payment server sends payment request information to the second user terminal, where the payment request information contains the transaction order.

If the order payment information sent from the first user terminal and acquired by the payment server includes the login account for the first user terminal to login the payment server and the transaction order, the payment request information contains the transaction order. If the order payment information sent from the first user terminal and acquired by the payment server includes the payment account assigned by the first user terminal, the payment request information contains the transaction order and the payment account.

S504: the second user terminal acquires verification information inputted by a user in respond to the payment request information.

After the second user terminal receives the payment request information sent from the payment server, the second user terminal acquires the verification information inputted by the user in respond to the payment request information, where the verification information includes fingerprint information, voice information, password information, and so on.

If the order payment information sent from the first user terminal and acquired by the payment server includes the login account for the first user terminal to login the payment server and the transaction order (the transaction order includes product information and an order number), based on the login account of the first user terminal, the payment server sends the payment request information to the second user terminal associated with the first user terminal, such that the user on the second user terminal determines the payment account and inputs the verification information in respond to the payment request information. Thus, the second user terminal acquires the payment account and the verification information.

If the order payment information sent from the first user terminal and acquired by the payment server includes the payment account assigned by the first user terminal and the transaction order (the transaction order includes product information and an order number), based on the payment account of the first user terminal, the payment server sends the payment request information to the second user terminal associated with the first user terminal, such that the user on the second user terminal inputs the verification information in respond to the payment request information for a payment account assigned by the first user terminal. Thus, the second user terminal acquires the verification information.

S505: the second user terminal sends payment confirmation information to the payment server, where the payment confirmation information contains the verification information.

If the order payment information sent from the first user terminal and acquired by the payment server includes the login account for the first user terminal to login the payment server and the transaction order (the transaction order includes product information and an order number), the payment confirmation information returned by the second user terminal based on the payment request information may contain the payment account assigned by the second user terminal and the verification information inputted by the user on the second user terminal in respond to the payment request information.

If the order payment information sent from the first user terminal and acquired by the payment server includes the payment account assigned by the first user terminal and the transaction order (the transaction order includes product information and an order number), the payment confirmation information returned by the second user terminal based on the payment request information may contain the verification information inputted by the user on the second user terminal in respond to the payment request information.

S506: when the payment server determines that the verification information in the payment confirmation information is the same as the predetermined verification information of the payment account, the payment server performs a payment operation for the transaction order.

If the payment confirmation information returned by the second user terminal based on the payment request information contains the payment account assigned by the second user terminal and the verification information inputted by the user on the second user terminal in respond to the payment request information, the payment server may determine whether the verification information in the payment confirmation information is the same as the predetermined verification information of the payment account assigned by the second user terminal. If the verification information in the payment confirmation information is the same as the predetermined verification information of the payment account, the payment server performs the payment operation for the transaction order. If the verification information in the payment confirmation information is different from the predetermined verification information of the payment account, the payment server may return transaction failure information to the second user terminal.

If the payment confirmation information returned by the second user terminal based on the payment request information contains the verification information inputted by the user on the second user terminal in respond to the payment request information, the payment server may determine whether the verification information in the payment confirmation information is the same as the predetermined verification information of the payment account assigned by the second user terminal. If the verification information in the payment confirmation information is the same as the predetermined verification information of the payment account, the payment server performs the payment operation for the transaction order. If the verification information in the payment confirmation information is different from the predetermined verification information of the payment account, the payment server may return transaction failure information to the second user terminal.

S507: the payment server sends a payment operation result of the transaction order to the first user terminal.

In the secure payment process shown in FIG. 5, the first user terminal sends the order payment information to the payment server. Based on the order payment information, the payment server sends the payment request information to the second user terminal. Based on the payment request information, the second user terminal returns the payment confirmation information to the payment server. The payment server performs the payment operation for the transaction order. The payment process is simplified, thereby improving efficiency of the online payment.

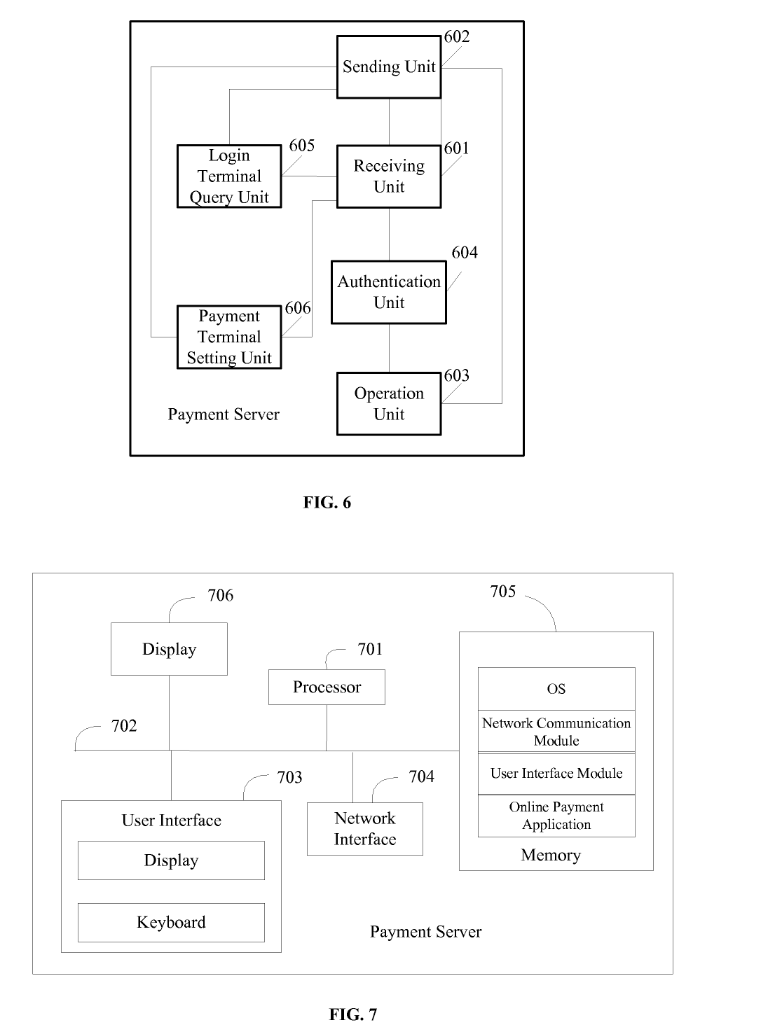

FIG. 6 illustrates a structure schematic diagram of an exemplary payment server consistent with the disclosed embodiments. The payment server may be a back-end server for a payment platform, such as PayPal, AliPay, Tenpay, etc. As shown in FIG. 6, the payment server may include a receiving unit 601, a sending unit 602, an operation unit 603, an authentication unit 604, a login terminal query unit 605, and a payment terminal setting unit 606.

The receiving unit 601 is configured to acquire order payment information sent from a first user terminal, where the order payment information includes a login account of the first user terminal and a transaction order.

The sending unit 602 is configured to, based on the login account of the first user terminal received by the receiving unit 601, send payment request information to a second user terminal associated with the first user terminal, where the payment request information contains the transaction order, and the second user terminal is a mobile terminal.

The receiving unit 601 is also configured to receive payment confirmation information returned from the second user terminal based on the payment request information sent by the sending unit 602.

The operation unit 603 is configured to, based on the payment confirmation information received by the receiving unit 601, perform a payment operation for the transaction order.

The sending unit 602 is also configured to send a payment operation result of the transaction order generated by the operation unit 603 to the first user terminal.

Optionally, if the payment confirmation information received by the receiving unit 601 contains a payment account and verification information inputted by a user on the second user terminal in respond to the payment request information, the payment server may also include the authentication unit 604 and the login terminal query unit 605.

The authentication unit 604 is configured to determine whether the verification information in the payment confirmation information received by the receiving unit 601 is the same as predetermined verification information of the payment account. If the verification information in the payment confirmation information received by the receiving unit 601 is the same as the predetermined verification information of the payment account, the authentication unit 604 triggers the operation unit 603 to perform the payment operation for the transaction order.

The login terminal query unit 605 is configured to acquire login terminal information of the login account of the first user terminal in the order payment information received by the receiving unit 601, where the login terminal information includes a terminal identifier of the first user terminal and a terminal identifier of the second user terminal.

Correspondingly, based on the terminal identifier of the second user terminal acquired by the login terminal query unit 605, the sending unit 602 is also configured to send the payment request information to the second user terminal.

The receiving unit 601 is also configured to receive payment terminal setting information sent from the first user terminal or the second user terminal.

Optionally, the payment server may also include the payment terminal setting unit 606.

The payment terminal setting unit 606 is configured to, based on the payment terminal setting information received by the receiving unit 601, set the second user terminal as a payment terminal associated with the first user terminal.

Correspondingly, based on the setting of the payment terminal setting unit 606, the sending unit 602 is also configured to send the payment request information to the second user terminal.

In the payment server shown in FIG. 6, the receiving unit 601 is configured to acquire the order payment information sent from the first user terminal, where the order payment information includes the login account of the first user terminal and the transaction order. The sending unit 602 is configured to, based on the login account of the first user terminal received by the receiving unit 601, send the payment request information to the second user terminal associated with the first user terminal. The receiving unit 601 is also configured to receive the payment confirmation information returned from the second user terminal based on the payment request information sent by the sending unit 602. The operation unit 603 is configured to, based on the payment confirmation information received by the receiving unit 601, perform the payment operation for the transaction order. The payment process is simplified, thereby improving efficiency of the online payment.

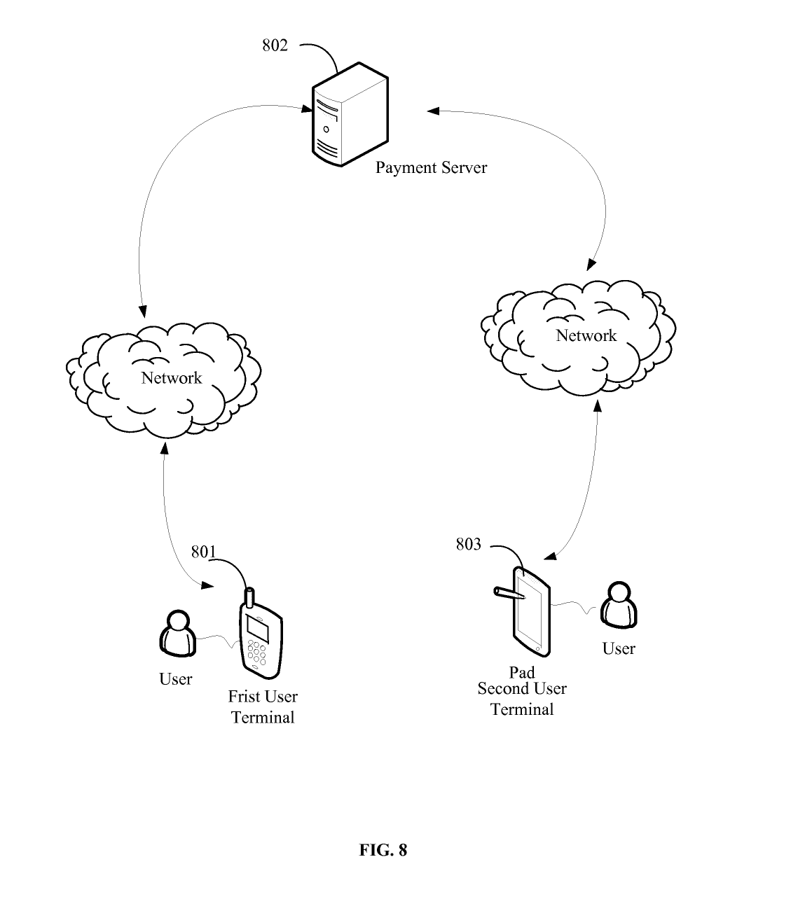

FIG. 7 illustrates a structure schematic diagram of another exemplary payment server consistent with the disclosed embodiments. As shown in FIG. 7, the payment server includes at least one processor 701, at least one network interface 704, a user interface 703, a memory 705, at least one communication bus 702.

The network interface 704, the memory 705, the processor 701, and the user interface 703 communicate with each other via one or more communication buses 702.

The user interface 703 may include a display screen (e.g., a liquid crystal display (LCD) or a cathode ray tube (CRT)), a keyboard, and other wired communication and/or wireless interface(s).

The network interface 704 may be an interface of a communication module, such as an interface of a network card. The communication interface 704 may include wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends Radio Frequency (RF) signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol.

The memory 705 is configured to store software programs, modules, instructions, and data structures. The one or more processors 701 are coupled to the memory 705 and operable to execute these programs, modules, and instructions, and read/write from/to the data structures stored in the memory 705 for implementing various functions of the payment server. The memory 705 includes a memory program area and a memory data area. The memory program area stores operating systems, network communication modules, user interface modules, applications (such as on-line payment applications, etc.), and so on. For example, an operating system includes various software components and/or drivers for controlling and managing general system tasks (e.g., memory management, storage device control, power management, etc.) and facilitates communications between various hardware, firmware, and software components.

The memory 705 may include high-speed random access memory (RAM), such as DRAM, SRAM, or other random access solid state memory devices. The memory 705 may also include non-volatile memory, such as one or more magnetic disk storage devices, optical disk storage devices, flash memory devices, or other non-volatile solid state storage devices.

The network interface 704 is configured to connect to user terminals and communicate data with a first user terminal and a second user terminal.

The processor 701 may include any appropriate processor or processors. Further, processor 701 can include multiple cores for multi-thread or parallel processing. The processor may be General Processor, central processing unit (CPU), Microprogrammed Control Unit (MCU), digital signal processor (DSP), graphics processing unit (GPU), system on a chip (SOC), application specific integrated circuits (ASIC), etc. The processor 701 is configured to execute the following operations by calling a secure payment application stored in the memory 705.

The processor 701 receives order payment information sent from a first user terminal via the network interface 704, where the order payment information includes a login account of the first user terminal and a transaction order.

The processor 701 also sends payment request information to a second user terminal associated with the first user terminal via the network interface 704, where the payment request information contains the transaction order.

Further, the processor 701 is configured to receive payment confirmation information corresponding to the payment request information sent from the second user terminal via the network interface 704.

The processor 701 is also configured to execute the following operations by calling a secure payment application stored in the memory 705.

The processor 701 receives login terminal information of the login account of the first user terminal via the network interface 704, where the login terminal information includes a terminal identifier of the first user terminal and a terminal identifier of the second user terminal.

The processor 701 receives payment terminal setting information sent from the first user terminal or the second user terminal via the network interface 704.

Further, the processor 701 is configured to execute the following operations by calling the secure payment application stored in the memory 705.

Based on the terminal identifier of the second user terminal of the login terminal information in the memory 705, the processor 701 sends the payment request information to the second user terminal.

Based on the payment terminal setting information in the memory 705, the processor 701 sets the second user terminal as a payment terminal associated with the first user terminal.

The processor 701 is also configured to send a payment operation result of the transaction order to the first user terminal via the network interface 704.

In the secure payment server shown in FIG. 7, based on the login account of the first user terminal, the payment server sends the payment request information to the second user terminal associated with the first user terminal. The payment server also receives the payment confirmation information returned from the second user terminal based on the payment request information. Based on the payment confirmation information, the payment server performs the payment operation for the transaction order sent by the first user terminal. The payment process is simplified, thereby improving efficiency of the online payment.

FIG. 8 illustrates a structure schematic diagram of an exemplary secure payment system consistent with the disclosed embodiment. As shown in FIG. 8, the secure payment system may include a first user terminal 801, a payment server 802, and a second user terminal 803. The first user terminal 801 and the second user terminal 803 may connect to the payment server 802 via a network, where the payment server 802 may be the above payment server described in FIG. 6 or FIG. 7.

The first user terminal 801 is configured to send order payment information to the payment server 802, where the order payment information includes a login account of the first user terminal 801 and a transaction order.

The payment server 802 is configured to, based on the login account of the first user terminal 801, send payment request information to the second user terminal 803 associated with the first user terminal 801, where the payment request information contains the transaction order, and the second user terminal 803 is a mobile terminal.

The second user terminal 803 is configured to, based on the payment request information, send payment confirmation information to the payment server 802.

The payment server 802 is also configured to, based on the payment confirmation information sent by the second user terminal 803, perform a payment operation for the transaction order.

The second user terminal 803 is also configured to, before sending the payment confirmation information to the payment server 802 based on the payment request information, acquire verification information inputted by a user in respond to the payment request information.

The payment confirmation information sent from the second user terminal 803 to the payment server 802 contains a payment account and the verification information inputted by the user.

Correspondingly, the payment server 802 is configured to determine whether the verification information in the payment confirmation information is the same as predetermined verification information of the payment account. If the verification information in the payment confirmation information is the same as the predetermined verification information of the payment account, the payment server 802 performs the payment operation for the transaction order. If the verification information in the payment confirmation information is different from the predetermined verification information of the payment account, the payment server 802 returns transaction failure information to the second user terminal.

The payment server 802 is also configured to acquire login terminal information of the login account of the first user terminal 801, where the login terminal information includes a terminal identifier of the first user terminal 801 and a terminal identifier of the second user terminal 803. Based on the terminal identifier of the second user terminal 803, the payment server 802 sends the payment request information to the second user terminal 803.

Further, the payment server 802 is configured to, before sending the payment request information to the second user terminal 803 associated with the first user terminal 801 based on the login account of the first user terminal 801, receive payment terminal setting information sent from the first user terminal 801 or the second user terminal 803, and set the second user terminal 803 as the payment terminal associated with the first user terminal 801 based on the payment terminal setting information.

The payment server 802 is also configured to, after performing the payment operation for the transaction order based on the payment confirmation information sent from the second user terminal 803, send a payment operation result of the transaction order to the first user terminal 801.

In the secure payment system shown in FIG. 8, the first user terminal 801 is configured to send the order payment information to the payment server 802. The payment server 802 is configured to, based on the order payment information, send payment request information to the second user terminal 803. The second user terminal 803 is configured to, based on the payment request information, return the payment confirmation information to the payment server 802. The payment server 802 performs the payment operation for the transaction order. The payment process is simplified, thereby improving efficiency of the online payment.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Skilled artisans may implement the described functionality in varying ways for each particular application, but such implementation decisions should not be interpreted as causing a departure from the scope of the present invention.

The steps of a method described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed secure payment methods, servers, and systems, based on an acquired login account of a first user terminal, the payment server sends payment request information to a second user terminal associated with the first user terminal. The payment server also receives payment confirmation information returned from the second user terminal based on the payment request information. Further, based on the payment confirmation information, the payment server performs a payment operation for the transaction order sent by the first user terminal. The secure payment methods, servers, and systems make online payment processing more efficient and convenient.

What is claimed is:

1. A secure payment method, comprising:
receiving, by a payment server, order payment information from a first user terminal, wherein the order payment information includes a login account of the first user terminal and a transaction order;
based on the login account of the first user terminal in the order payment information, sending, by the payment server, payment request information to a second user terminal associated with the first user terminal, wherein the payment request information contains the transaction order, and the second user terminal is a mobile terminal;
based on the payment request information, receiving, by the payment server, payment confirmation information from the second user terminal, wherein the payment confirmation information contains a payment account and verification information inputted by a user on the second user terminal in respond to the payment request information; and
based on the payment confirmation information sent from the second user terminal, performing, by the payment server, a payment operation for the transaction order.

2. The method according to claim 1, further including:
acquiring, by the second user terminal, the verification information inputted by the user in respond to the payment request information;
sending, by the second user terminal, the verification information to the payment server; and
determining, by the payment server, whether the verification information is the same as predetermined verification information of the payment account, wherein:
when the verification information in the payment confirmation information is the same as the predetermined verification information of the payment account, the payment server performs the payment operation for the transaction order; and
when the verification information in the payment confirmation information is different from the predetermined verification information of the payment account, the payment server returns transaction failure information to the second user terminal.

3. The method according to claim 1, wherein, based on the login account of the first user terminal, sending payment request information to a second user terminal associated with the first user terminal further includes:
acquiring, by the payment server, login terminal information of the login account of the first user terminal, wherein the login terminal information includes a terminal identifier of the first user terminal and a terminal identifier of the second user terminal; and
based on the terminal identifier of the second user terminal, sending, by the payment server the payment request information to the second user terminal.

4. The method according to claim 1, before sending payment request information to a second user terminal associated with the first user terminal based on the login account of the first user terminal, further including:
receiving, by the payment server, payment terminal setting information sent from any one of the first user terminal and the second user terminal; and
based on the payment terminal setting information, setting the second user terminal as a payment terminal associated with the first user terminal.

5. The method according to claim 1, after performing a payment operation for the transaction order based on the payment confirmation information sent from the second user terminal, further including:
sending, by the payment server, a payment operation result of the transaction order to the first user terminal.

6. The method according to claim 1, further including:
acquiring, by the payment server, the order payment information sent from the first user terminal, wherein the order payment information includes the login account of the first user terminal and the transaction order;
based on the login account of the first user terminal, sending, by the payment server, the payment request information to the second user terminal associated with the first user terminal, wherein the payment request information includes the transaction order, and the second user terminal is the mobile terminal;
receiving, by the payment server, the payment confirmation information returned from the second user terminal based on the payment request information, wherein the payment confirmation information contains the payment account and the verification information inputted by the user on the second user terminal in respond to the payment request information; and
based on the payment confirmation information, performing, by the payment server, the payment operation for the transaction order.

7. The method according to claim 6, wherein performing the payment operation based on the payment confirmation information further includes:
determining, by the payment server, whether the verification information in the payment confirmation information is the same as the predetermined verification information of the payment account, wherein:
when the verification information in the payment confirmation information is the same as the predetermined verification information of the payment account, the payment server performs the payment operation for the transaction order; and
when the verification information in the payment confirmation information is different from the predetermined verification information of the payment account, the payment server returns the transaction failure information to the second user terminal.

8. The method according to claim 6, wherein sending the payment request information to the second user terminal associated with the first user terminal further includes:
acquiring, by the payment server, the login terminal information of the login account of the first user terminal, wherein the login terminal information includes a terminal identifier of the first user terminal and a terminal identifier of the second user terminal; and
based on the terminal identifier of the second user terminal, sending, by the payment server, the payment request information to the second user terminal.

9. The method according to claim 6, before sending the payment request information to the second user terminal associated with the first user terminal based on the login account of the first user terminal, further including:
receiving, by the payment server, the payment terminal setting information sent from any one of the first user terminal and the second user terminal; and
setting, by the payment server, the second user terminal as the payment terminal associated with the first user terminal.

10. The method according to claim 6, after performing the payment operation for the transaction order based on the payment confirmation information, further including:
sending, by the payment server, the payment operation result of the transaction order to the first user terminal.

11. A payment server, comprising:
a receiving unit configured to acquire order payment information sent from a first user terminal, wherein the order payment information includes a login account of the first user terminal and a transaction order;
a sending unit configured to, based on the login account of the first user terminal, send payment request information to a second user terminal associated with the first user terminal, wherein the payment request information contains the transaction order, and the second user terminal is a mobile terminal;
the receiving unit also configured to receive payment confirmation information returned from the second user terminal based on the payment request information, wherein the payment confirmation information contains a payment account and verification information inputted by a user on the second user terminal in respond to the payment request information; and
an operation unit configured to, based on the payment confirmation information, perform a payment operation for the transaction order.

12. The payment server according to claim 11, further including:
an authentication unit configured to determine whether the verification information in the payment confirmation information is the same as predetermined verification information of the payment account, wherein:
when the verification information in the payment confirmation information is the same as the predetermined verification information of the payment account, the authentication unit triggers the operation unit to perform the payment operation for the transaction order.

13. The payment server according to claim 11, further including:
a login terminal query unit configured to acquire login terminal information of the login account of the first user terminal, wherein the login terminal information includes a terminal identifier of the first user terminal and a terminal identifier of the second user terminal; and
the sending unit configured to, based on the terminal identifier of the second user terminal acquired by the login terminal query unit, send the payment request information to the second user terminal.

14. The payment server according to claim 11, further including:
the receiving unit also configured to receive payment terminal setting information sent from any one of the first user terminal and the second user terminal;
an payment terminal setting unit configured to, based on the payment terminal setting information, set the second user terminal as a payment terminal associated with the first user terminal; and
the sending unit configured to, based on setting of the payment terminal setting unit, send the payment request information to the second user terminal.

15. The payment server according to claim 11, further including:
the sending unit also configured to send a payment operation result of the transaction order to the first user terminal.

16. A secure payment system, comprising:
a first user terminal configured to send order payment information to a payment server, wherein the order payment information includes a login account of the first user terminal and a transaction order;
the payment server configured to, based on the login account of the first user terminal, send payment request information to a second user terminal associated with the first user terminal, wherein the payment request information contains the transaction order, and the second user terminal is a mobile terminal;
the second user terminal configured to, based on the payment request information, send payment confirmation information to the payment server, wherein the payment confirmation information contains a payment account and verification information inputted by a user; and
the payment server also configured to, based on the payment confirmation information sent by the second user terminal, perform a payment operation for the transaction order.

17. The system according to claim 16, further including:
the second user terminal configured to, before sending the payment confirmation information to the payment server based on the payment request information, acquire the verification information inputted by the user on the second user terminal in respond to the payment request information; and
the payment server also configured to determine whether the verification information in the payment confirmation information is the same as predetermined verification information of the payment account, wherein:
when the verification information in the payment confirmation information is the same as the predetermined verification information of the payment account, the payment server performs a payment operation for the transaction order; and
when the verification information in the payment confirmation information is different from the predetermined verification information of the payment account, the payment server returns transaction failure information to the second user terminal.

18. The system according to claim 16, wherein the payment server is also configured to:
acquire login terminal information of the login account of the first user terminal, wherein the login terminal information includes a terminal identifier of the first user terminal and a terminal identifier of the second user terminal; and
based on the terminal identifier of the second user terminal, send the payment request information to the second user terminal.

19. The system according to claim 16, wherein the payment server is further configured to:
before sending the payment request information to the second user terminal associated with the first user terminal based on the login account of the first user terminal, receive payment terminal setting information from any one of the first user terminal and the second user terminal; and
based on the payment terminal setting information, set the second user terminal as a payment terminal associated with the first user terminal.

20. The system according to claim 16, wherein the payment server is further configured to:
after performing the payment operation for the transaction order based on the payment confirmation information sent from the second user terminal, send a payment operation result of the transaction order to the first user terminal.
